(19) United States
(12) Patent Application Publication
(10) Pub. No.: US 2026/0165333 A1
(43) Pub. Date: Jun. 18, 2026

(54) METHOD AND SYSTEM FOR PROVIDING SMALL SAUSAGE PORTIONS

(71) Applicant: VEMAG Maschinenbau GmbH, Verden (DE)

(72) Inventor: Manuel Otten, Kirchlinteln (DE)

(21) Appl. No.: 19/425,328

(22) Filed: Dec. 18, 2025

(30) Foreign Application Priority Data
Dec. 18, 2024 (DE) 102024138724.6

(51) Int. Cl. A22C 15/00

(52) U.S. Cl. CPC A22C 15/001

(57) ABSTRACT

A system and method are developed for providing portions of pasty food mass. The method includes (a) providing portions of pasty food mass located in a casing by a first portioning apparatus, and (b) providing portions of pasty food mass located in a casing by a second portioning apparatus. The method also includes (c) transferring the portions from each of the first and second portioning apparatuses to hooks of a shared suspension machine, and then (d) transporting the hooks in a transport direction. In a further step (e), a number of hooks is determined, which must pass by the second portioning apparatus in the transport direction without portions being transferred to the hooks from the second portioning apparatus, to facilitate a gapless and non-overlapping draping on the hooks. In a step (f) a controller skips the determined number of hooks to synchronize the outputs of the two portioning apparatuses.

### CROSS-REFERENCE TO RELATED APPLICATION

This application is a claims priority to German Application No. 102024138724.6, filed Dec. 18, 2024. The above-mentioned patent application is incorporated herein by reference in its entirety.

### TECHNICAL FIELD

This application relates to a method for providing portions of pasty food mass provided in a casing, in particular small sausage portions, in which: a) portions of pasty food mass located in a casing are provided by a first portioning apparatus, b) portions of pasty food mass located in a casing are provided by a second portioning apparatus, c) the portions are transferred to hooks of a shared suspension machine, d) after the transfer of the portions, the hooks are further transported in a transport direction by the suspension machine.

### BACKGROUND

A method of this type is used, for example, in production lines for sausages. In this type of small sausage production line, the pasty sausage meat is provided from a filling machine, filled into a casing made from natural or artificial sausage casing, and divided into individual small sausage portions by twisting. A portioning apparatus with portioning belts provides the small sausage portions forming a string of sausages in the desired lengths and weights, and further transports the same to a suspension machine, where the strings of sausages are grouped, transferred, and suspended in various suspension patterns. Thus, for example, a certain number of small sausages may be transferred to one of multiple hooks of the suspension machine, so that a loop of small sausages drapes down from the hook.

In the case where a so-called continuous production process is present, in which hooks are to be guided, preferably continuously, to a cooking system, a best practice is to use two portioning apparatuses, so that also, when a so-called casing change is carried out at one portioning apparatus, the other portioning apparatus then guarantees a draping on the hooks. Therefore, a number of hooks to be draped depends on the total length of the casing, the number of small sausages per hook, the

product length of the portions, and the number of twists between the portions. The hooks actually draped are counted and entered into the program of the continuous cooking system as a recipe parameter. However, since the continuous chain of hooks is to be draped by two portioning apparatuses, a gap, in the form of empty hooks, is created by the suspension machine after each portioning procedure, wherein this corresponds to the number quantitatively entered in the recipe in the prior art.

In practice, it has been shown that it may occur that the hooks to be draped and the empty hooks located therebetween, which are stored in the corresponding system, do not necessarily correspond to the actually observed state, and it may thus occur to some extent that the first portioning apparatus and the second portioning apparatus no longer synchronously drape the hooks. This may also have the result that hooks are doubly draped and products are not correctly cooked or smoked in the cooking system. As a result, under certain circumstances, the products are also not cooked, or are at least not visually appealing, when they are to be packaged for sale at the end of the cooking process.

In this context, the underlying object of the invention is to further develop a method of the type mentioned at the outset, so that the disadvantages occurring in the prior art may be remedied as much as possible. In particular, it would be desirable to provide a method in which a synchronization of the first portioning apparatus and the second portioning apparatus is improved.

### SUMMARY

To achieve these and other technical objectives, the present invention in first embodiments provides a method of the type mentioned at the outset. The method further includes e) a number of hooks is determined, which must pass by the second portioning apparatus in the transport direction, without portions being transferred to the hooks from the second portioning apparatus, in order to facilitate a gapless and non-overlapping draping on the hooks of the shared suspension machine, and f) a controller of the second portioning apparatus is controlled such that, for the certain number of hooks, no portions are transferred to the hooks from the second portioning apparatus, and after the number of hooks has passed by, portions are transferred to the hooks from the second portioning apparatus.

The present invention makes use of the fact that, due to the determination of the number of hooks which must pass by the second portioning apparatus in the transport direction, without portions being transferred to the hooks from this portioning apparatus, and a relevant control of the second portioning apparatus, it may be achieved that the second portioning apparatus is always synchronized with respect to the first portioning apparatus, so that a gapless and non-overlapping draping of the hooks of the shared sus-pension machine is facilitated. In other words, a relation is thus established between the first portioning apparatus and the second portioning apparatus. After the end of portioning by the first portioning apparatus, that is for example, after this has draped a certain number of hooks, the second portioning apparatus may start seamlessly, in that it initially skips, so to speak, the certain number of hooks and, after the number of hooks has passed by, portions are transferred to the hooks from the second portioning apparatus.

According to one embodiment, a number of hooks is provided or determined, which are located on the suspension machine between the first portioning apparatus and the second portioning apparatus, and a number of hooks is provided or determined, which are to be draped by the first portioning apparatus, wherein the number of hooks which must pass by the second portioning apparatus without portions being transferred to the hooks, is determined based on the number of hooks which are located on the suspension machine between the first portioning apparatus and the second portioning apparatus, and the number of hooks which are to be draped by the first portioning apparatus.

According to one embodiment, the number x of hooks, which must pass by the second portioning apparatus without portions being transferred to the hooks, is determined depending on the number n of hooks, which are located on the suspension machine between the first portioning apparatus and the second portioning apparatus, and the number p of hooks, which are to be draped by the first portioning apparatus, by way of the following formula:

$$x = p - ( ( n - p ) modulo p ) .$$

The result x of the calculation is the number of hooks, which must proceed without a transfer of portions to the hooks, in order to facilitate a gapless and non-overlapping draping of the hooks. In order to implement this, a product supply tube of the second portioning apparatus may rotate, for example, without thereby supplying products to the suspension machine, so that the hooks, which are preferably arranged on a continuous chain, move up. After a successful moving up of the hooks, the regular portioning and transfer process may be carried out from the second portioning apparatus to the sus-pension machine.

This is to be illustrated by a numerical example, in which it is assumed that a total of n=200 hooks is arranged between the first and second portioning apparatus, and that respectively p=48 hooks are to be draped in succession by each portioning apparatus. The result of the calculation according to the formula x=p−((n−p) modulo p) is x=40 for the above values.

In the case that the first portioning apparatus drapes the hooks 1-48, the second portioning apparatus the hooks 49-96, the first portioning apparatus the hooks 97-144, and the second portioning apparatus the hooks 145-192. As the first portioning apparatus drapes 48 hooks starting at hook 193 to hook 240, the second portioning apparatus must rotate, without transferring portions, for x=40 hooks, namely for the hooks 200 to 240, so that the hooks 200 to 240 are not doubly draped. By this arrangement, it is ensured that the second portioning apparatus is synchronized to the first portioning apparatus, and the hooks of the suspension machine may be draped in a gapless and non-overlapping way.

According to one embodiment, the second portioning apparatus has a looper horn, drivable by a drive, wherein the draping in step f) is carried out in such a way that the looper horn of the second portioning apparatus rotates for the number of hooks, without transferring portions to the hooks, and after the number of hooks has passed by, rotates and transfers portions to the following hooks.

According to one embodiment, the number of the hooks passing by the second portioning apparatus is determined based on a sensor signal of the cooking and/or smoking system. Such a system typically has the corresponding sensors, so that sensor data already obtained in this way may also be advantageously used for the method according to the invention.

According to one embodiment, the determination in step f) is carried out at an end of portioning of the first portioning apparatus, in particular after the desired number of hooks has been draped from the first portioning apparatus. Naturally, the determination in step f) may also be carried out at other points in time, wherein then, if necessary, the formula is adapted, so that it ensures that the hooks are draped in a gapless and non-overlapping way.

According to one embodiment, the method is further refined in that, in the case that the first portioning apparatus has actually draped a number of hooks, where the number is smaller than the planned number of hooks to be draped, g) a number of hooks is deter-mined which must pass by the second portioning apparatus, without portions being transferred to the hooks, in order to facilitate a gapless and non-overlapping draping of the hooks of the shared suspension machine, h) the controller of the second portioning apparatus is controlled such that, for the number determined based on step g), no portions are transferred to the hooks from the second portioning apparatus, and after the number of hooks has passed by, portions are transferred to the hooks from the second portioning apparatus.

This refinement of the method makes use of the fact that, so-called production interruptions occasionally occur in practice, in which the desired number of hooks is not draped by a portioning apparatus, but instead a lower number. Due to the refinement of the method according to the invention, the second portioning apparatus may effectively react to this, and also in the case, that a lower number of hooks was actually draped than planned, it may be synchronized with the first portioning apparatus in such a way that also in this type of case, a non-overlapping draping on the hooks is ensured.

The number y of hooks in step g) is preferably determined depending on the number of hooks I actually draped, the number n of hooks, which are located on the suspension machine between the first portioning apparatus and the second portioning apparatus, and the number p of hooks, which are to be draped by the first portioning apparatus, by way of the following formula:

$$y = p - ( ( n - l ) modulo p ) .$$

Once again, the draping may be carried out in such a way that the looper horn of the second portioning apparatus rotates for the number of hooks, without portions being transferred to the hooks, and after the number of hooks has passed by, it rotates and transfers portions to the following hooks.

According to one embodiment, the looper horn is equipped to rotate both forward and also backward. The drive of the hooks is thereby also preferably synchronized with the looper horn. Because the looper horn and also the hooks may be moved both forwards and also backwards, or in two directions, the detection of a position, at which the portioning procedure is to be started, is facilitated. For example, it may be significantly faster to get past a lower number of hooks over the course of a backwards movement than, for example, a large number of hooks, for example, 20 or 30 hooks, in the course of a forward movement.

The invention has previously been described with reference to a method. In additional embodiments, the invention relates to a portioning apparatus for providing portions of pasty food mass located in a casing, which has a looper horn, drivable by a drive, which is equipped to transfer multiple portions, connected to one another by the casing, to a suspension machine, and respectively a controller for controlling components of the portioning apparatus.

The invention solves the problem described at the outset with respect to the portioning apparatus, in that the controller is designed and equipped to carry out the method according to one of the preceding exemplary embodiments. The portioning apparatus makes use of the same advantages and preferred embodiments as the method according to the invention and vice versa. In this respect, reference is made to the above embodiments and their content is included here.

According to one embodiment, food mass located in a casing may be transferred to the portioning apparatuses from a filling machine with a delivery pipe upstream of the respective portioning apparatus, wherein the looper horn is arranged at the outlet area of the respective portioning apparatus in order to be able to transfer portions in a desired number per time unit and with a desired target weight to the looper horn, and that, on the outlet side downstream of the looper horn, the hooks of the suspension machine may be moved in the transport direction such that a desired number of portions may be transferred from the looper horn to the hooks of the suspension machine.

In another set of embodiments, the invention relates to a system for providing portions of pasty food mass provided in a casing, in particular small sausage portions, and for carrying out a method according to at least one of the preceding exemplary embodiments, having a first portioning apparatus for providing portions of pasty food mass located in a casing, which has a looper horn, drivable by a drive, which is designed to transfer multiple portions, connected to one another by the casing, to a suspension machine, a second portioning apparatus for providing portions of pasty food mass located in a casing, which has a looper horn, drivable by a drive, which is equipped to transfer multiple portions, connected to one another by the casing, to a suspension machine, a suspension machine for transporting multiple portions, which has multiple hooks for receiving multiple portions, connected by the casing, wherein the hooks may be further transported by at least one circulating drive element drivable by a drive, and a controller for controlling components of the portioning apparatus.

The invention solves the problem described at the outset with respect to the system, in that the controller is designed and equipped to carry out the method described above. The system also makes use of the same advantages and preferred embodiments as the method according to the invention and the portioning apparatus according to the invention and vice versa. To prevent repetitions, reference is made to the above embodiments and their content is included here.

According to one embodiment, the system further has a cooking and/or smoking system, wherein the suspension machine is equipped to supply portions, received on the hooks, to the cooking and smoking system. Because it is ensured that the hooks are not doubly draped, the products may be correctly cooked and smoked in the cooking and/or smoking system. By this means, visually appealing products are generated, which have a uniform degree of cooking when they are to be packaged for sale at the end of the cooking.

The present invention also relates to a computer program product. The invention solves the problem described at the outset with respect to the computer program product, in that this comprises commands, which effect that the portioning apparatus according to one of the preceding exemplary embodiments carries out the steps of the method according to one of the preceding exemplary embodiments. The computer program product also makes use of the same advantages and preferred embodiments as the method according to the invention, the portioning apparatus according to the invention, and the system according to the invention and vice versa. In this respect, reference is made to the above embodiments and their content is included here.

### BRIEF DESCRIPTION OF THE DRAWINGS

The embodiments of the invention are now subsequently described with reference to the appended Figures.

FIG. 1 is a perspective view of one exemplary embodiment of a system for providing portions of pasty food mass provided in a casing, in particular small sausage portions.

FIG. 2 is a side view of the exemplary embodiment of the system according to FIG. 1.

FIG. 3 is a schematic diagram showing the method according to embodiments of the invention.

FIG. 4 is a schematic depiction of a first set of exemplary calculation results of the method according to embodiments of the invention.

FIG. 5 is a schematic depiction similar to FIG. 4, but of a second set of exemplary calculation results of the method.

### DETAILED DESCRIPTION

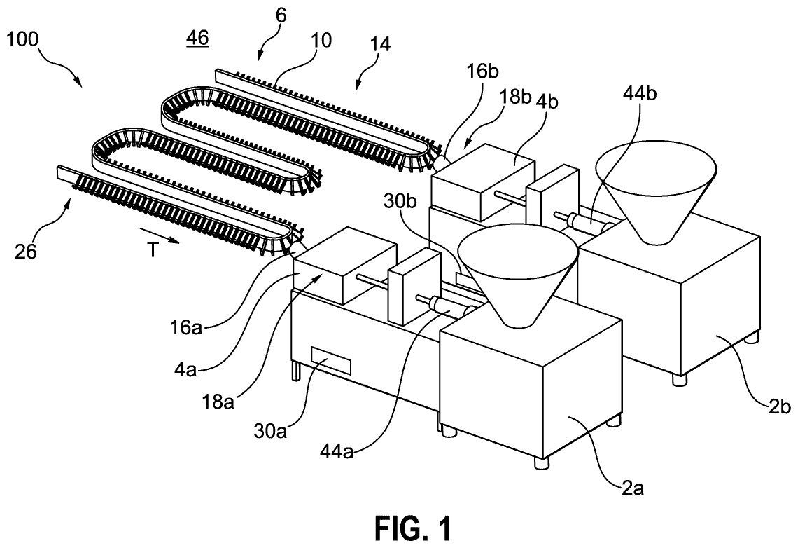

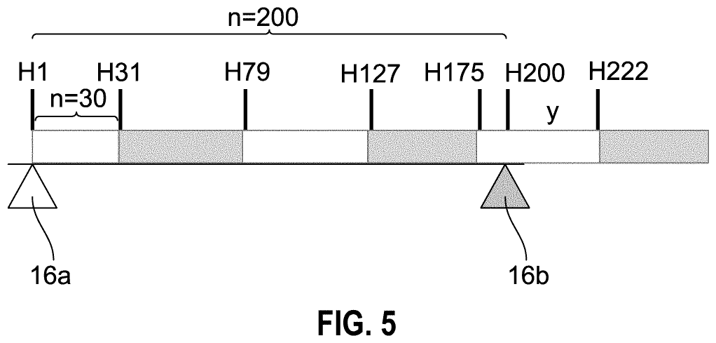

FIG. 1 shows a system 100 for providing portions P of pasty food mass provided in a casing, in particular small sausage portions. The system 100 is equipped to carry out the method illustrated in FIG. 5. The system 100 has a first portioning apparatus 4a. The portioning apparatus 4a is equipped to provide portions P of pasty food mass located in a casing. The first portioning apparatus 4a has a looper horn 16a drivable by a drive 18a. The looper horn 16a is designed to transfer multiple portions P, connected to one another by the casing, to a suspension machine 6.

The system 100 additionally has a second portioning apparatus 4b. The second portioning apparatus 4b is equipped to provide portions P of pasty food mass located in a casing. The second portioning apparatus 4b also has a looper horn 16b drivable by a drive 18b. The looper horn 16b is designed to transfer multiple portions P, connected to one another by the casing, to a suspension machine 6. The system 100 further has a suspension machine 6 for transporting multiple portions P. The suspension machine 6 has multiple hooks 14 for receiving multiple portions P connected by the casing. The hooks 14 may be further transported by at least one circulating drive element 10 drivable by a drive 26, in particular in the transport direction T, shown in FIG. 1; however also in the opposite direction in certain circumstances. In addition, each of the portioning apparatuses 4a, 4b has a controller 30a, 30b. This is respectively equipped to carry out the method according to FIG. 5.

A filling machine 2a, 2b with a delivery pipe 44a, 44b, upstream of the respective portioning apparatuses 4a, 4b, may transfer food mass located in a casing to the respective portioning apparatus 4a, 4b. The respective looper horn 16a, 16b, is arranged at the outlet area of the respective portioning apparatus 4a, 4b in order to transfer portions P, in a desired number per time unit and with a desired target weight, to the looper horn 16a, 16b. The system 100 further has a cooking and/or smoking system 46, wherein the suspension machine 6 is equipped to supply portions, received on the hooks 14, to the cooking and smoking system 46.

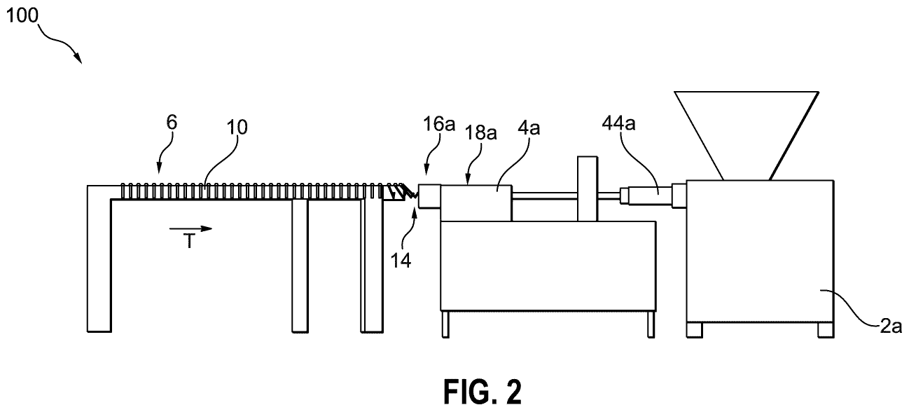

The system 100 is shown in a side view in FIG. 2, which, due to the selected perspective, shows the first filling machine 2a, from which pasty mass is supplied via the delivery pipe 44a to the first portioning apparatus 4a. After the portioning, a transfer of the generated portions, in particular small sausages, to the hooks 14 of the suspension machine 6 is carried out by the looper horn 16a, driven by a drive 18a. As is exemplarily depicted in FIG. 2, the suspension machine 6 is driven with the aid of a drive element 10 so that the hooks 14 may be preferably transported in transport direction T.

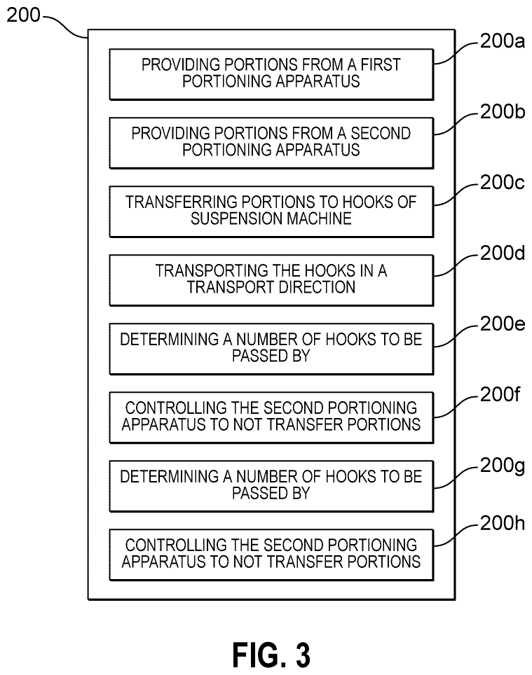

FIG. 3 shows a block diagram of a method 200 according to the invention for providing portions P of pasty food mass provided in a casing, in particular small sausage portions. In the method 200, the following steps are provided: 200(a) portions P of pasty food mass located in a casing are provided by a first portioning apparatus 4a; 200(b) portions P of pasty food mass located in a casing are provided by a second portioning apparatus 4b; 200(c) the portions P are transferred to hooks 14 of a shared suspension machine 6 shown in FIGS. 1 and 2; and 200(d) after the transfer of the portions P, the hooks 14 are further transported in the transport direction T by the suspension machine 6.

According to the method, furthermore in step 200(e) a number x of hooks 14 is determined, which must pass by the second portioning apparatus 4b in the transport direction T, without portions P being transferred from the second portioning apparatus 4b to the hooks 14, in order to facilitate a gapless and non-overlapping draping of the hooks 14 of the shared suspension machine 6. Furthermore, the method has the step 200(f), according to which a controller 30b of the second portioning apparatus 4b is controlled such that, for the determined number x of hooks 14, no portions are transferred from the second portioning apparatus 4b to the hooks 14, and after the number x of hooks 14 has passed by, portions are transferred from the second portioning apparatus 4b to the hooks 14.

A number n of hooks 14 is thereby provided or determined, which are located on the suspension machine 6 between the first portioning apparatus 4a and the second portioning apparatus 4b. Furthermore, a number p of hooks 14 is provided or determined, which are to be draped by the first portioning apparatus 4a.

The number x of hooks 14, which must pass by the second portioning apparatus 4b, without portions P being transferred to the hooks, is determined based on the number n of hooks 14, which are located on the suspension machine 6 between the first portioning apparatus 4a and the second portioning apparatus 4b, and the number p of hooks 14, which are to be draped by the first portioning apparatus 4a.

In particular, the number x of hooks 14, which must pass by the second portioning apparatus 4b, without portions P being transferred to the hooks 14, is determined depending on the number n of hooks 14, which are located on the suspension machine 6 between the first portioning apparatus 4a and the second portioning apparatus 4b, and the number p of hooks 14, which are to be draped by the first portioning apparatus 4a, by way of the following formula:

$$x = p - ( ( n - p ) modulo p ) .$$

In the case that, as shown in FIGS. 1 and 2, the second portioning apparatus 4b has a looper horn 16b drivable by a drive 18b, the draping in step 200(f) is carried out in such a way that the looper horn 16b of the second portioning apparatus 4b rotates for the number x of hooks 14, without transferring portions to the hooks 14, and after the number x of hooks 14 has passed by, rotates and transfers portions to the following hooks 14. The number of the hooks 14 passing by the second portioning apparatus 4b may thereby be determined, for example, based on a sensor signal of the cooking and/or smoking system 46 shown in FIG. 1. The determination in step 200(f) may be carried out at an end of portioning of the first portioning apparatus 4a, in particular after p hooks have been draped by the first portioning apparatus 4a.

In the case that the first portioning apparatus 4a has actually draped a number I of hooks, where the number I is smaller than the planned number p of hooks to be draped, then the method steps 200(g) and 200(h) are preferably carried out. These method steps are relevant, in particular for scenarios, in which, for example, due to a so-called production interruption, the number of hooks actually draped does not correspond to the planned number p. In such a case, in step 200(g) a number y of hooks 14 is determined, which must pass by the second portioning apparatus 4b, without portions P being transferred to the hooks 14, in order to facilitate a gapless and non-overlapping draping of hooks 14 of the shared suspension machine 6. Furthermore, in step 200(h), the controller 30b of the second portioning apparatus 4b is controlled such that, based on the number y determined in step 200(g), no portions are transferred from the second portioning apparatus 4b to the hooks 14, and after the number y of hooks 14 has passed by, portions are transferred from the second portioning apparatus 4b to the hooks. The number y of hooks 14 in step 200(g) is thereby preferably determined depending on the number of hooks I actually draped, the number n of hooks 14, which are located on the suspension machine 6 between the first portioning apparatus 4a and the second portioning apparatus 4b, and the number p of hooks 14, which are to be draped by the first portioning apparatus 4a, by way of the following formula:

$$y = p - ( ( n - l ) modulo p ) .$$

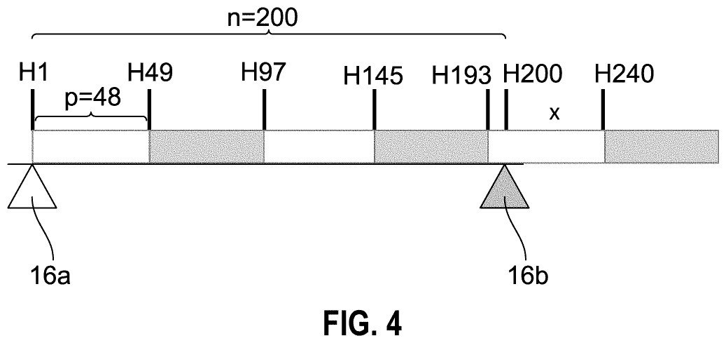

The method will now be illustrated in FIGS. 4 and 5 by way of a specific numerical example.

FIG. 4 relates, in particular, to method steps 200(e) and 200(f). According to step 200(e) the number x of hooks 14 is determined, which must pass by the second portioning apparatus 4b in the transport direction T, without portions P being transferred from the second portioning apparatus 4b to the hooks 14, in order to facilitate a gapless and non-overlapping draping of hooks 14 of the shared suspension machine 6. For this purpose, a number n of hooks 14 is initially provided or determined, which are located on the suspension machine 6 between the first portioning apparatus 4a and the second portioning apparatus 4b. In the example shown in FIGS. 4, 200 hooks 14 are arranged between the portioning apparatuses 4a, 4b. In addition, a number p of hooks 14 is provided or determined, which are to be draped by the first portioning apparatus 4a. In the example provided here, it is assumed that 48 hooks are to be draped by the first portioning apparatus 4a. The result of the calculation according to the formula x=p−((n−p) modulo p) is x=40 for the above values.

In the state shown in FIG. 4, the first portioning apparatus 4a drapes the hooks 1-48, the second portioning apparatus 4b the hooks 49-96, the first portioning apparatus 4a the hooks 97-144, and the second portioning apparatus 4b the hooks 145-192. As the first portioning apparatus 4a drapes the hooks 193-240, the second portioning apparatus 4b must rotate without transferring portions for x=40 hooks, namely for the hooks 200 to 240, so that the hooks 200 to 240 are not doubly draped.

In other words, this means that a total of 40 hooks are to be skipped by the second portioning apparatus 4b, which means, for example, that the looper horn 16b of the second portioning apparatus 4b rotates for eight hooks 40, without transferring portions to the hooks 14, and after the 40 hooks have passed by, portions are transferred to the following hooks 14 by further rotation of the looper horn 16b. By this means, it is assured that the hooks are draped in a gapless and non-overlapping manner. If, for example, as depicted in FIG. 4, a first hook H1 is assigned to the first portioning apparatus 4a, then the second portioning apparatus 4b may only then begin with the draping when the hook H241 has been guided to the same, that is, after 40 hooks 14 have passed by.

FIG. 5 illustrates the partial method described with reference to the method steps 200(g) and 200(h). The case addressed therein is that the first portioning apparatus 4a has actually draped a number I of hooks, where the number I is smaller than the planned number p of hooks 14 to be draped. In the present example, the planned number p of hooks to be draped is 48. In actuality, the first portioning apparatus 4a has merely draped I=30 hooks, for example, as a result of a so-called production interruption. In this case, the determination of the number n of hooks 14, which are to pass by the second portioning apparatus 4b, before portions are transferred to the hooks 14, is carried out by way of the following formula:

$$y = p - ( ( n - l ) modulo p ) .$$

In the present example, the result of the calculation is y=22, so that 22 hooks must pass by the second portioning apparatus 4b, without portions being transferred to the hooks 14.

In the state shown in FIG. 5, the first portioning apparatus 4a drapes the hooks 1-30, the second portioning apparatus 4b the hooks 31-78, the first portioning apparatus 4a the hooks 79-126, the second portioning apparatus 4b the hooks 127-174, and the first portioning apparatus the hooks 175-222. If, for example, as depicted in FIG. 5, a first hook H1 is assigned to the first portioning apparatus 4a, then the second portioning apparatus 4b may only then begin with the draping when the hook H223 has been guided to the same, that is, after 22 hooks 14 have passed by. Upon reaching the hook H223, the transfer process may be started. This prevents that hooks are doubly draped in the case of a production interruption.

The embodiments described above are only descriptions of preferred embodiments of the present invention, and are not intended to limit the scope of the present invention. Various variations and modifications can be made to the technical solution of the present invention by those of ordinary skills in the art, without departing from the design and spirit of the present invention. The variations and modifications should all fall within the claimed scope defined by the claims of the present invention.

What is claimed is:

1. A method for providing portions of pasty food mass provided in a casing, comprising the following steps:
(a) providing portions of pasty food mass located in a casing by a first portioning apparatus,
(b) providing portions of pasty food mass located in a casing by a second portioning apparatus,
(c) transferring the portions from each of the first and second portioning apparatuses to hooks of a shared suspension machine,
(d) transporting, after the transfer of portions, the hooks by the suspension machine in a transport direction,
(e) determining a number of hooks, which must pass by the second portioning apparatus in the transport direction, without portions being transferred from the second portioning apparatus to the hooks, to facilitate a gapless and non-overlapping draping of hooks of the shared suspension machine, and
(f) controlling using a controller of the second portioning apparatus such that, for the determined number of hooks, no portions are transferred from the second portioning apparatus to the hooks, and after the determined number of hooks has passed by, portions are again transferred from the second portioning apparatus to the hooks.

2. The method according to claim 1, wherein:
a number of hooks is provided or determined, which are located on the suspension machine between the first portioning apparatus and the second portioning apparatus,
a number of hooks is provided or determined, which are to be draped by the first portioning apparatus, and
the number of hooks, which must pass by the second portioning apparatus, without portions being transferred to the hooks, is determined based on the number of hooks, which are located on the suspension machine between the first portioning apparatus and the second portioning apparatus, and the number of hooks, which are to be draped by the first portioning apparatus.

3. The method according to claim 2, wherein the number of hooks, which must pass by the second portioning apparatus without portions being transferred to the hooks, is determined depending on the number of hooks, which are located on the suspension machine between the first portioning apparatus and the second portioning apparatus, and the number of hooks, which are to be draped by the first portioning apparatus, by way of a formula:
$$x = p - ( ( n - p ) modulo p ) .$$

4. The method according to claim 1, wherein the second portioning apparatus also has a looper horn, drivable by a drive, and
wherein the draping in step (f) is carried out in such a way that the looper horn of the second portioning apparatus rotates for the determined number of hooks, without portions being transferred to the hooks, and after the determined number of hooks has passed by, the looper horn then rotates and transfers portions to subsequent hooks.

5. The method according to claim 4, wherein the determined number of hooks passing by the second portioning apparatus is determined based on a sensor signal of a cooking and/or smoking system.

6. The method according to claim 1, wherein the determination in step (e) is carried out at an end of portioning of the first portioning apparatus, and after hooks have been draped by the first portioning apparatus.

7. The method according to claim 1, wherein when the first portioning apparatus has actually draped a number of hooks, and where the number of hooks actually draped is smaller than a planned number of hooks to be draped, the method further comprises the steps:
(g) determining a number of hooks, which must pass by the second portioning apparatus, without portions being transferred to the hooks, to facilitate a gapless and non-overlapping draping of hooks of the shared suspension machine,
(h) controlling the controller of the second portioning apparatus such that based on the number determined in step (g), no portions are transferred from the second portioning apparatus to the hooks, and
after the determined number of hooks has passed by, portions are transferred again from the second portioning apparatus to the hooks.

8. The method according to claim 7, wherein the determined number of hooks in step (g) is determined depending on the number of hooks actually draped, the number of hooks, which are located on the suspension machine between the first portioning apparatus and the second portioning apparatus, and the number of hooks, which are to be draped by the first portioning apparatus, by way of a formula:
$$y = p - ( ( n - l ) modulo p ) .$$

9. A portioning apparatus for providing portions of pasty food mass located in a casing, which has a looper horn, drivable by a drive, which is designed to transfer multiple portions, connected to one another by the casing, to a suspension machine, and respectively a controller for controlling components of the portioning apparatus,
wherein the controller is designed and equipped to carry out a method comprising:
(a) providing portions of pasty food mass located in a casing by a first portioning apparatus,
(b) providing portions of pasty food mass located in a casing by a second portioning apparatus,
(c) transferring the portions from each of the first and second portioning apparatuses to hooks of the suspension machine,
(d) transporting, after the transfer of portions, the hooks by the suspension machine in a transport direction,
(e) determining a number of hooks, which must pass by the second portioning apparatus in the transport direction, without portions being transferred from the second portioning apparatus to the hooks, to facilitate a gapless and non-overlapping draping of hooks of the shared suspension machine, and
(f) controlling using the controller such that, for the determined number of hooks, no portions are transferred from the second portioning apparatus to the hooks, and after the determined number of hooks has passed by, portions are again transferred from the second portioning apparatus to the hooks.

10. The portioning apparatus according to claim 9, wherein food mass located in a casing can be transferred to the respective portioning apparatuses by a filling machine with a delivery pipe upstream of the respective portioning apparatus,
wherein the looper horn is arranged at an outlet area of the respective portioning apparatus to be able to transfer portions in a desired number per time unit and with a desired target weight to the looper horn, and
wherein, on an outlet side downstream of the looper horn, the hooks of the suspension machine can be moved in the transport direction such that a desired number of portions can be transferred from the looper horn to the hooks of the suspension machine.

11. A system for providing portions of pasty food mass provided in a casing, the system comprising:
a first portioning apparatus for providing portions of pasty food mass located in a casing, which has a looper horn, drivable by a drive, which is designed to transfer multiple portions, connected to one another by the casing, to a suspension machine,
a second portioning apparatus for providing portions of pasty food mass located in a casing, which has a looper horn, drivable by a drive, which is designed to transfer multiple portions, connected to one another by the casing, to a suspension machine,
a suspension machine for transporting multiple portions, which has multiple hooks for receiving multiple portions connected by the casing, wherein the hooks may be further transported by at least one circulating drive element drivable by a drive,
a controller for controlling components of the portioning apparatus, characterized in that the controller is designed and equipped to carry out a method comprising:
(a) providing portions of pasty food mass located in a casing by the first portioning apparatus,
(b) providing portions of pasty food mass located in a casing by the second portioning apparatus,
(c) transferring the portions from each of the first and second portioning apparatuses to hooks of the suspension machine,
(d) transporting, after the transfer of portions, the hooks by the suspension machine in a transport direction,
(e) determining a number of hooks, which must pass by the second portioning apparatus in the transport direction, without portions being transferred from the second portioning apparatus to the hooks, to facilitate a gapless and non-overlapping draping of hooks of the shared suspension machine, and
(f) controlling using the controller such that, for the determined number of hooks, no portions are transferred from the second portioning apparatus to the hooks, and after the determined number of hooks has passed by, portions are again transferred from the second portioning apparatus to the hooks.

12. The system according to claim 11, further comprising a cooking and/or smoking system, wherein the suspension machine is equipped to supply portions, received on the hooks, to the cooking and/or smoking system.

13. A computer program product, comprising orders, which effect that a portioning apparatus carries out steps of a method according to claim 1.
